(19) United States
(12) Patent Application Publication
(10) Pub. No.: US 2019/0246822 A1
(43) Pub. Date: Aug. 15, 2019

(54) REUSABLE BEVERAGE STORAGE AND DISPENSING SYSTEM

(71) Applicant: Warren Russel Horwitz, Toronto (CA)

(72) Inventor: Warren Russel Horwitz, Toronto (CA)

(21) Appl. No.: 15/893,658

(22) Filed: Feb. 11, 2018

(51) Int. Cl. A47G 19/23; A47J 41/02

(52) U.S. Cl. CPC A47G 19/23; A47J 41/02

(57) ABSTRACT

A reusable beverage storage and dispensing system that allows at least two reusable cups to be attached to the system and wherein the two cups will not visibly increase the footprint of the beverage storage and dispensing system. The reusable beverage storage and dispensing system comprises of a beverage bottle having a top and a bottom, a silicone elastic band that is secured to the bottle at a certain distance from the bottom of the bottle and a first and a second cup. The circumference of the first cup being larger that the circumference of the bottom of the bottle and the circumference of the second cup being larger than the circumference of the first cup. The first cup will snugly fit within the second cup and the bottle will snugly fit within the first cup. Upon the bottle, the first cup and the second cup being stacked within each other, the silicon elastic band shall secure the second cup on the bottle.

### BACKGROUND

The present invention is directed to a reusable beverage storage and dispensing system.

The present invention was conceived by the inventor on a weekend getaway.

He had gone to go the beach and wanted to share a bottle of wine with his significant other. At the beach he realized that he did not have the needed cup ware or glassware to enjoy his beverage, so he was forced to either look at the beverage or drink it out of the bottle.

The dilemma caused the inventor to conceive a reusable beverage storage system that would have at least two cups that would become part of the system so that the footprint of the beverage container would not be visibly increased by the cups and wherein the cups would be reusable after their use.

The system would have to be designed not to not shock the conscience of the consumer of the beverage and ideally would use a vacuum flask type bottle.

For the foregoing reasons there is a need for a reusable beverage storage and dispensing system that will allow at least two reusable cups to be attached to the system and wherein the two cups will not visibly increase the footprint of the beverage storage and dispensing system.

### SUMMARY

The present invention describes a reusable beverage storage and dispensing system that allows at least two reusable cups to be attached to the system and wherein the two cups will not visibly increase the footprint of the beverage storage and dispensing system.

The reusable beverage storage and dispensing system comprises of a bottle having a top and a bottom, a silicone elastic band that is secured to the bottle at a certain distance from the bottom of the bottle and a first and a second cup. The circumference of the first cup being larger that the circumference of the bottom of the bottle and the circumference of the second cup being larger than the circumference of the first cup. The first cup will snugly fit within the second cup and the bottle will snugly fit within the first cup. Upon the bottle, the first cup and the second cup being stacked within each other, the silicon elastic band shall secure the second cup on the bottle. The certain distance can be in the range from at least two inches to at most 7 inches from the bottom of the bottle.

In a preferred embodiment the bottle 10 will be a vacuum flask.

An object of the present invention is to provide a reusable beverage storage and dispensing system 100 that will allow at least two reusable cups to be attached to the system and wherein the two cups will not visibly increase the footprint of the beverage storage and dispensing system.

Another object of the present invention is to provide a reusable beverage storage system that will maintain the contents within the beverage storage system at a certain temperature.

Yet another object of the present invention is to provide a reusable beverage storage and dispensing system that will allow a user to have reusable cups without visibly maximizing the footprint of the bottle of the system.

Yet another object of the present invention is to provide a reusable beverage storage and dispensing system that will allow at least two people two drink from their own distinct cup.

### DRAWINGS

These and other features, aspects, and advantages of the present invention will become better understood with regard to the following description, appended claims, and drawings where:

FIG. 1 is a perspective view of a reusable beverage storage and dispensing system that shows a first cup, a second cup, a bottle, and a silicon band that is folded in an upward position on the cup;

FIG. 2 is a perspective view of the reusable beverage storage and dispensing system, wherein the first cup is snugly fit within the second cup;

FIG. 3 is a perspective view of the reusable beverage storage and dispensing system, wherein first and second cups are snugly fit on the bottle, yet the silicon band is still in the upward position on the cup; and

FIG. 4 is a perspective view of the reusable beverage storage and dispensing system, wherein first and second cups are snugly fit on the bottle, and the silicon band is unfolded so that the bottom part of the silicon band secures the first and second cup on the bottle.

### DESCRIPTION

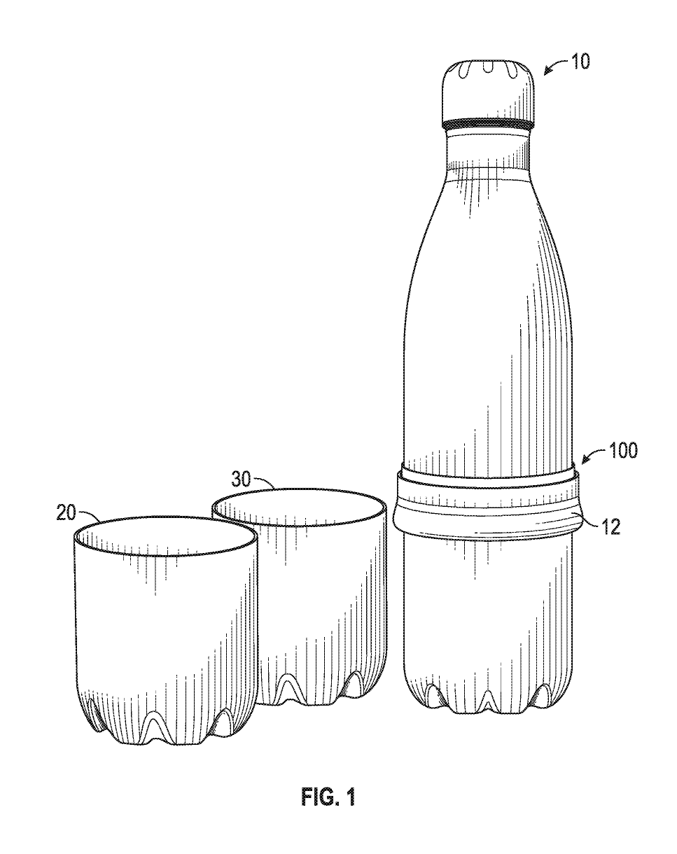

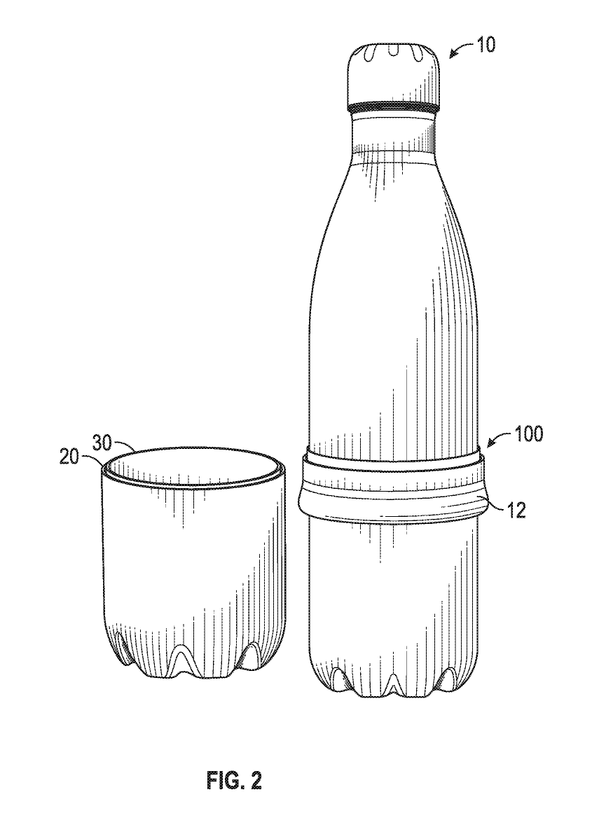

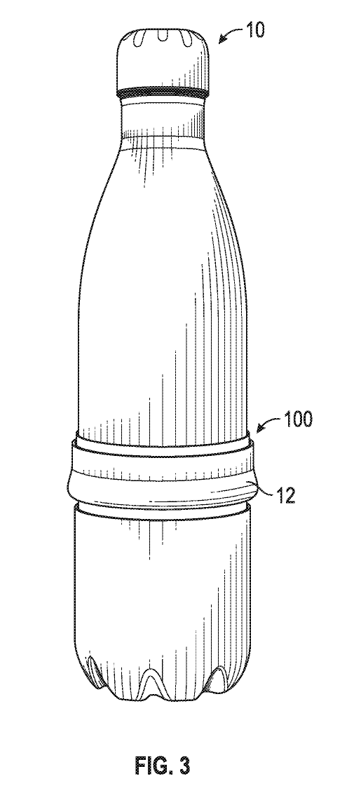

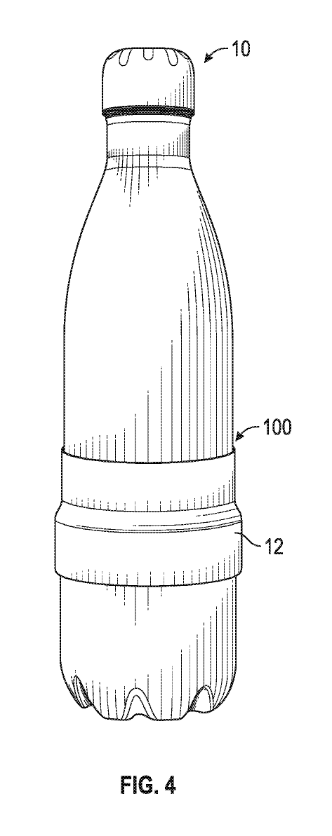

As seen in FIGS. 1-4, the present invention is a reusable beverage storage and dispensing system 100. The system 100 comprises of a beverage bottle 10 that has a top and bottom a bottom circumference, a silicone elastic band 12 that is secured to the bottle 10 at a certain distance from the bottom of the bottle and a first 30 and a second cup 20 and each having a circumference. The circumference of the first cup 30 being larger that the bottom circumference of the bottle 10 and the circumference of the second cup 20 being larger than the circumference of the first cup 30. The first cup 30 will snugly fit within the second cup 20 and the bottom of the bottle 10 will snugly fit within the first cup 30. Upon the bottle 10, the first cup 30 and the second cup 20 being stacked within each other, the silicon elastic band 12 shall secure the second cup 20 on the bottle 10. The certain distance can be in the range from at least two inches to at most 7 inches from the bottom of the bottle 10.

In a preferred embodiment the bottle will be a vacuum flask. In another embodiment, the elastic band can be made of any elastic material.

In other embodiment, it is foreseen that a a third and fourth cup can be used to cover the second cup and be secured by the elastic band on the bottle (not shown in figures).

An advantage of the present invention is that it provides a reusable beverage storage and dispensing system that allows at least two reusable cups to be attached to the system and wherein the two cups will not visibly increase the footprint of the beverage storage and dispensing system.

Another advantage of the present invention is that it provides a reusable beverage storage system that maintains the contents within the beverage storage system at a certain temperature.

Yet another advantage of the present invention is that it provides a reusable beverage storage and dispensing system that allows a user to have reusable cups without visibly maximizing the footprint of the bottle of the system.

Yet another advantage of the present invention is that it provides a reusable beverage storage and dispensing system that allows at least two people two drink from their own distinct cup.

While the inventor's above description contains many specificities, these should not be construed as limitations on the scope, but rather as an exemplification of several preferred embodiments thereof. Many other variations are possible. For example, the use of multiple cups that will snugly fit around the outer cups of the present invention. Accordingly, the scope should not be determined by the embodiments illustrated, but by the appended claims and their legal equivalents.

What is claimed is:

1. A reusable beverage storage and dispensing system, the system comprises:
a beverage bottle that has a top and a bottom and a bottom circumference;
an elastic band that is secured to the bottle at a certain distance from the bottom of the bottle;
a first and a second cup and each having a circumference, wherein the circumference of the first cup is larger than the bottom circumference of the bottle and the circumference of the second cup being larger than the circumference of the first cup, wherein the first cup snugly fits within the second cup and the bottom of the bottle snugly fits within the first cup, and wherein the elastic band secures the first and second cup on the bottle after the bottle is inserted within the first cup.

2. The reusable beverage storage and dispensing system of claim 1, wherein the elastic band is made of silicone.

3. The reusable beverage storage and dispensing system of claim 2, wherein the bottle is a vacuum flask.

4. The reusable beverage storage and dispensing system of claim 2, wherein the certain distance that the elastic band is secured on the bottle is in the range from at least two inches to at most 7 inches from the bottom of the bottle.

5. The reusable beverage storage and dispensing system of claim 5, the system comprises of at least a third cup that has a greater circumference than the circumference of the second cup and the second cup being inserted within the third cup and the elastic band securing the third cup on the bottle.

6. The reusable beverage storage and dispensing system of claim 6, the system comprises of at least a fourth cup that has a greater circumference than the circumference of the third cup and the third cup being inserted within the fourth cup and the elastic band securing the fourth cup on the bottle.
